(19) United States
(12) Patent Application Publication
(10) Pub. No.: US 2009/0002568 A1
(43) Pub. Date: Jan. 1, 2009

(54) INFORMATION PROCESSOR, CONTROL METHOD AND DISPLAY SYSTEM OF THE SAME

(75) Inventors: Kazunobu Konda, Tokyo (JP); Shigeru Maeda, Tachikawa-shi (JP); Hideki Ohkita, Kunitachi-shi (JP); Ken Matsushita, Tama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/163,471

(22) Filed: Jun. 27, 2008

(30) Foreign Application Priority Data
Jun. 29, 2007 (JP) 2007-173488

(51) Int. Cl. H04N 5/268; H04N 5/91

(52) U.S. Cl. 348/705; 386/46; 348/E05.057

(57) ABSTRACT

According to one embodiment, an information processor includes a first connection unit, a second connection unit which is different from the first connection unit, receiving a reproduction request signal of content data from an external terminal, a start-up unit which transmits the control signal to start up the display device from the first connection unit when receiving the reproduction request signal for the content data stored in the external terminal, a decoding unit which decodes the content data to be received from the external terminal through the second connection unit, and an output unit which outputs a video signal of the content data decoded by the decoding unit from the first connection unit.

### CROSS-REFERENCE TO RELATED APPLICATIONS

This application is based upon and claims the benefit of priority from Japanese Patent Application No. 2007-173488, filed Jun. 29, 2007, the entire contents of which are incorporated herein by reference.

### BACKGROUND

1. Field

One embodiment of the present invention related to an information processor of a personal computer, etc., and more specifically relates to an information processor having a cooperation function with a television (TV) receiver, and a control method and a display system of the information processor.

2. Description of the Related Art

In general, TV receivers with connection terminals of high-definition multimedia interface (HDMI) system have become widely used. For instance, as described in Jpn. Pat. APPln. KOKAI Publication No. 2006-19947, TV receivers in a digital system have connection terminals of HDMIs and digital visual interfaces (DVIs). The TV receivers in the digital system may display while switching inputs from the connection terminals of the HDMIs and the DVIs.

However, a technique described in Jpn. Pat. APPln. KOKAI Publication No. 2006-19947 has a problem such that the power of the TV receiver in the digital system for a display of content data has to be turned on in displaying the decoded content data from the apparatus connected through the HDMI on the TV receiver, etc. For instance, when the content data has been received from external apparatuses, if a user intends to display the video of the content data on the TV receiver, it is needed for the external apparatuses to issue reproduction instructions of the content data and also to switch video inputs through the HDMI to the external apparatuses by operating the TV receiver. That is, the user has to each operate each of the apparatuses and the operations bother the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view depicting an overview of a display system regarding an embodiment of the invention;

FIG. 2 is an exemplary block diagram depicting an example of a configuration of a display system regarding the embodiment of the invention;

FIG. 3 is an exemplary block diagram depicting a configuration of a function of a computer regarding the embodiment of the invention;

FIG. 4 is an exemplary flowchart depicting a control method to which a display system regarding the embodiment of the invention is applied; and

FIG. 5 is an exemplary flowchart depicting a control method to which a display system regarding the embodiment of the invention is applied.

### DETAILED DESCRIPTION

Various embodiments according to the invention will be described hereinafter with reference to the accompanying drawings. In general, according to one embodiment of the invention, an information processor includes: a first connection unit which outputs a video signal to a display device and communicating a control signal with the display device; a second connection unit which is different from the first connection unit, receiving a reproduction request signal of content data from an external terminal and receiving the content data; a start-up unit which transmits the control signal to start up the display device from the first connection unit when receiving the reproduction request signal for the content data stored in the external terminal; a decoding unit which decodes the content data to be received from the external terminal through the second connection unit after starting up the display device by the start-up unit; and an output unit which outputs a video signal of the content data decoded by the decoding unit from the first connection unit.

Hereinafter, embodiments of the present invention will be described by referring to the drawings.

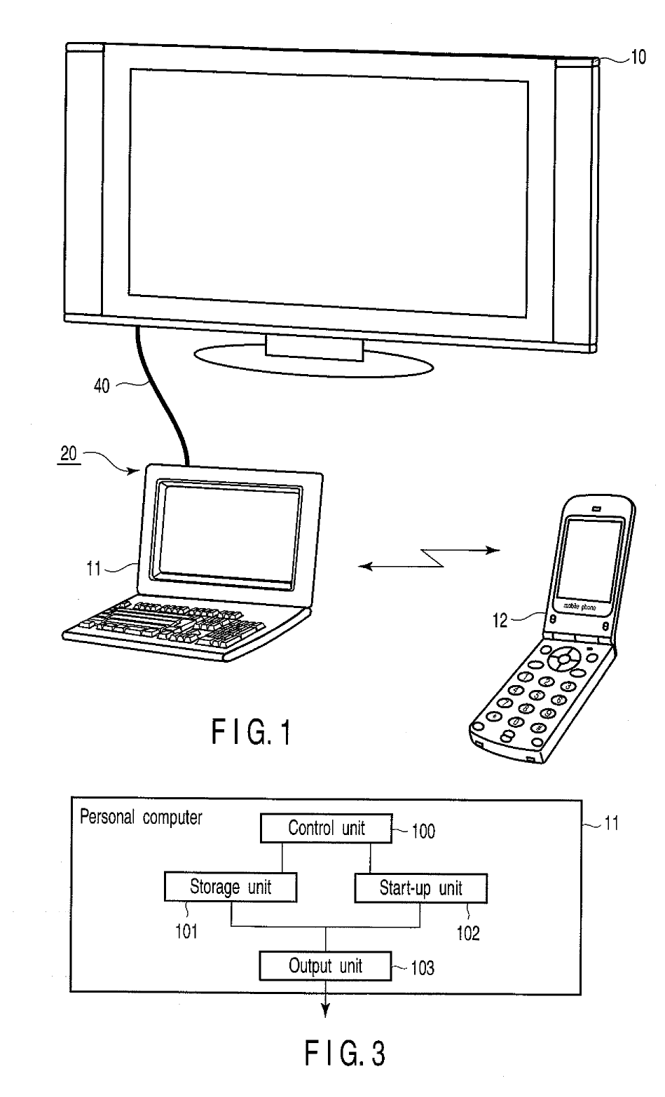

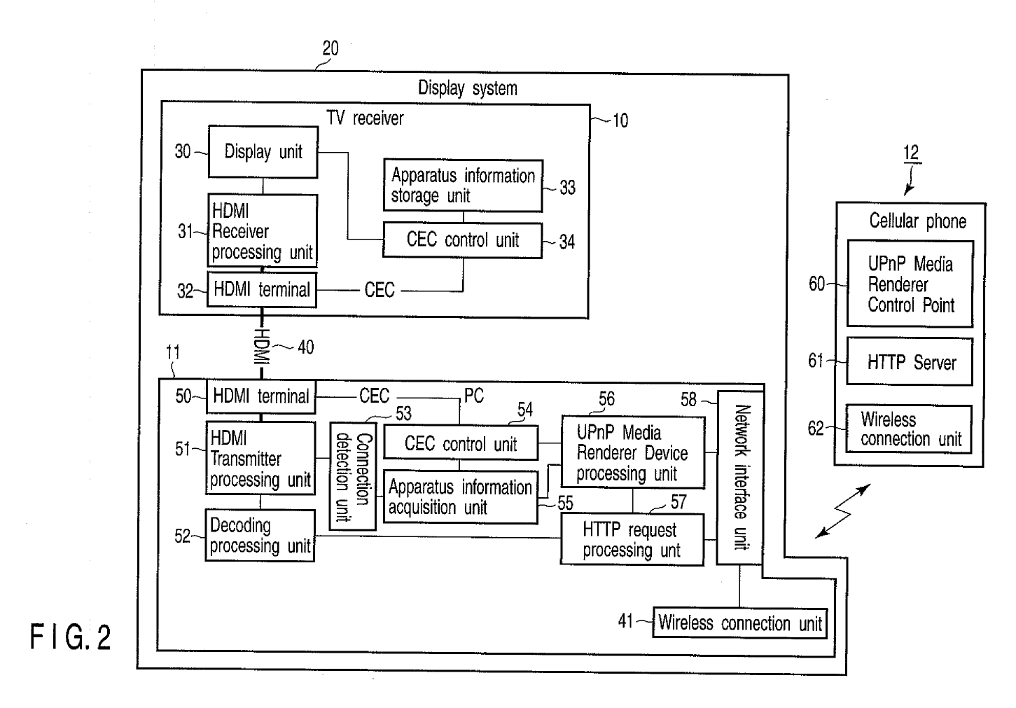

With reference to FIGS. 1 and 2, the configuration of an information processor regarding an embodiment of the invention will be described. The information processor has been achieved, for example, as a notebook-type personal computer (referred to as a PC) 11, and has been configured as a display system 20.

The display system 20 is composed of a TV receiver 10, the PC 11, etc., as shown in FIG. 1.

The PC 11 is connected to the TV receiver 10 through a high-definition multimedia interface (HDMI) cable. A cellular phone 12 is connectable with the PC 11 by unit of wireless connection by which communication is made through the transmission control protocol (TCP)/Internet Protocol (IP) (TCPIP) on a wireless LAN, etc.

Here, in the embodiment, it is assumed that the PC 11 and the cellular phone 12 make communication on the basis of the Universal Plug and Play (UPnP) standard. In the UPnP, a specification that is UPnP AV Architecture is defined for an AV apparatus. In this UPnP AV Architecture, as a basic configuration of a network, a device, a service and a control point are defined. The device is an apparatus corresponding to the UPnP and AV, the service is a minimum unit indicating a function to be provided by the device. Each device is an apparatus to be controlled and having at least one Service. The control point controls and utilizes the service owned by the device. One apparatus may include a plurality of devices, and furthermore, an apparatus with the control point and the device integrated therein is a possible approach.

Further, in the UPnP AV architecture, a UPnP media server device is defined as a server device which mounts a function to be controlled and provides content data.

In the embodiment, the PC 11 functions as the UPnP Media Renderer Device providing a function to reproduce the content data. Further, the cellular phone 12 functions as a UPnP media renderer control point for controlling the device to issue a reproduction instruction, and an HTTP server (or media server device) for supplying the content data to the UPnP Media Renderer Device to be provided by the PC 11.

FIG. 2 is a block diagram depicting a configuration of the display device, etc.

The TV receiver 10 forming a part of the display system 20 is composed of a display unit 30 that is a display unit, an HDMI receiver processing unit 31, an HDMI terminal 32, an apparatus information storage unit 33 and a consumer electronics control (CEC) control unit 34, etc. The processing unit 31 receives video data and a control command of HDMI-CEC through the HDMI terminal 32 and the HDMI cable (a first connection unit). The storage unit 33 stores the apparatus information of the TV receiver 10. The apparatus information of the TV receiver 10 may be arbitrarily set, for example, set to ‘My TV’. The control unit 34 executes and controls the control command of the received HDMI-CEC.

The PC 11 forming a part of the display system 20 includes an HDMI terminal 50, an HDMI transmitter processing unit 51, a decoding processing unit 52, a connection detection unit 53, a CEC control unit 54, an apparatus information acquisition unit 55, a UPnP Media Renderer Device processing unit (reproduction function provision unit: providing a function as a Media Renderer Device) 56, an HTTP request processing unit 57, a network interface unit 58, and a wireless connection unit 41 (a second connection unit).

The HDMI transmitter processing unit 51 transmits video data, a control command of the HDMI-CEC, etc., to the TV receiver 10 via the HDMI terminal 50. The decoding processing unit 52 decodes the content data received from the cellular phone, etc. The connection detection unit 53 detects whether or not the connection has been completed to the TV receiver 10 via the HDMI terminal 50. The CEC control unit 54 executes and controls the HDMI-CEC. The apparatus information acquisition unit 55 acquires apparatus information (apparatus name information) of the TV receiver 10 from an apparatus information storage unit 33. The UPnP Media Renderer Device processing unit 56 converts the control command received from the cellular phone 12 into the control command of the HDMI-CEC. The HTTP request processing unit 57 receives the content data from the cellular phone 12. The network interface unit 58 is connected to the wireless connection unit 41 that is an access point, etc. of the wireless LAN and is connectable to the cellular phone 12 via the wireless connection unit 41.

The cellular phone 12 has a UPnP media renderer control point 60, an HTTP server 61, and a wireless connection unit 62. The control point 60 generates a command of ‘play’, ‘stop’, etc., that are the control commands. The HTTP server 61 delivers control data. The wireless connection unit 62 makes wireless connection with the PC 11.

FIG. 3 shows a functional block diagram indicating the configuration of the PC 11.

The PC 11 is provided with a control unit 100, a storage unit 101, a start-up unit 102, and an output unit 103. The control unit 100 includes a CPU, etc., detects the decoding processing of the content data and the connection of the HDMI terminal, and transfers the control command. The storage unit 101 temporarily stores the content and the control command received from the cellular phone 12, and stores the apparatus information, etc., received from the TV receiver 10. The start-up unit 102 transmits the control command to the TV receiver 10 and performs such an operation to turn on the TV receiver 10. The output unit 103 outputs the control command received from the cellular phone 12 and decoded content data (video data) to the TV receiver 10.

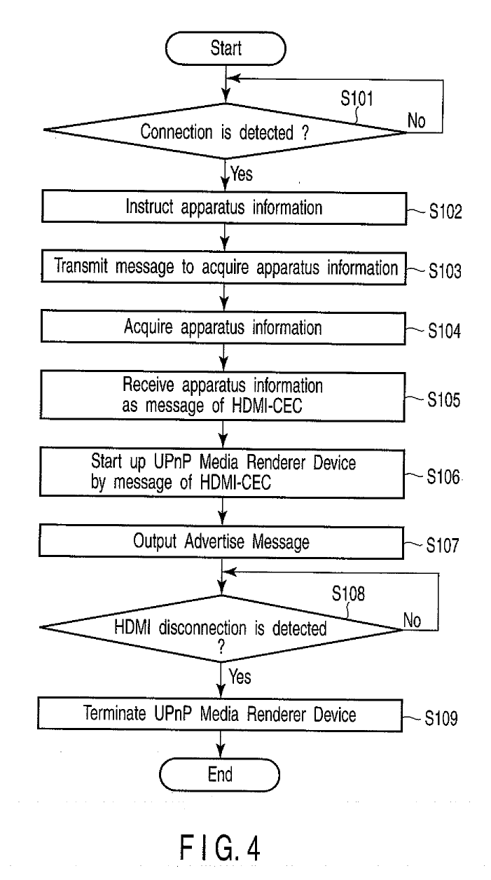

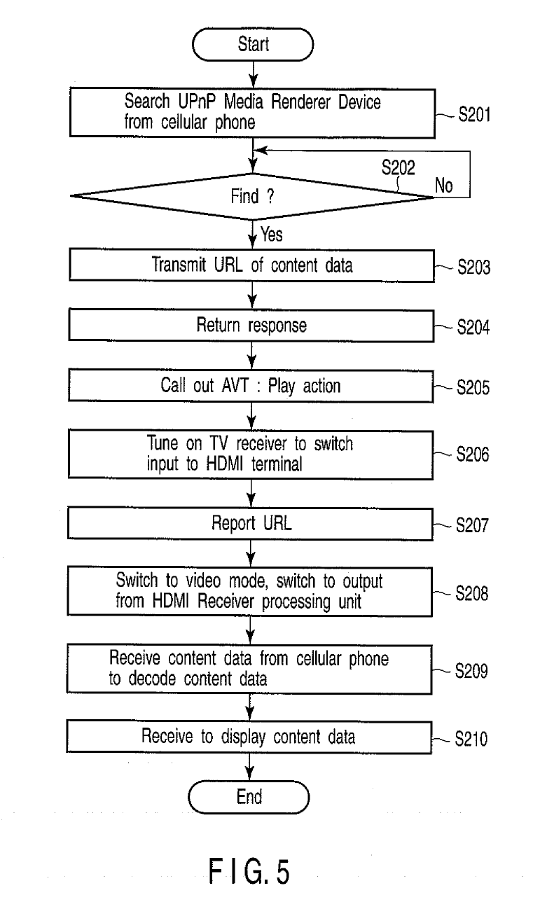

Next, with referring to FIGS. 4 and 5, a control method to which the information processor of the display device regarding the embodiment of the invention has been applied will be described.

FIG. 4 is a flowchart illustrating the star-up processing of the display system.

The connection detection unit 53 of the computer 11 detects whether or not the TV receiver 10 has been connected to the PC 11 that is an HDMI source apparatus by unit of a physical address setting function defined by the HDMI standard to be executed by the HDMI transmitter processing unit 51 (Block S101). When the detection unit 53 of the PC 11 detects that the TV receiver 10 has been to the PC 11 (YES Block S101), the detection unit 53 issues an instruction to the information acquisition unit 55 so as to acquire the apparatus information of the TV receiver 10 (Block S102). The information acquisition unit 55 issues an instruction to the CEC control unit 54 of the PC 11 so as to transmit a massage for an apparatus information acquisition request in order to acquire the apparatus information (Block S103). The message for the apparatus information acquisition request is transferred to the TV receiver 10 via the HDMI terminals 50. After receiving the message for the request, the control unit 34 of the CEC of the TV receiver 10 acquires the apparatus information from the apparatus information storage unit 33 (Block S104). The apparatus information is the name set to the TV receiver 10 in advance, and in this embodiment, as mentioned above, the apparatus has been named ‘My TV’.

The apparatus information is transferred to the PC 11 as a message of the HDMI-CEC, the CEC control unit 54 of the PC 11 receives the message (Block S105), and the control unit 54 transfers the message of the HDMI-CEC to the information acquisition unit 55. The acquisition unit 55 sets the message form the HDMI-CEC to the UPnP Media Renderer Device processing unit 56 as a value of a ‘friendly name’ element in the device description of the UPnP media renderer, and issues an instruction so as to start up the UPnP Media Renderer Device processing unit 56. Next, the processing unit 56 starts up the UPnP Media Renderer Device (a function as a network interface that is a reproduction device) (Block S106). The network interface unit 58 outputs an ‘advertise message’ (Block S107). In this state, the cellular phone 12 may browse the name of the apparatus ‘My TV’ of the TV receiver 10.

Meanwhile, when the user removes the HDMI terminal 50 from the PC 11 and if the connection with the PC 11 is disconnected (YES Block S108), the detection unit 53 of the computer 11 detects the fact of the release of the connection from the HDMI transmitter processing unit 51, and issues an instruction to the UPnP Media Renderer Device processing unit 56 so as to terminate the UPnP Media Renderer Device. The processing unit 56 performs termination processing of the UPnP Media Renderer Device, outputs an advertise message from the network interface unit 58 to end the processing (Block S109).

FIG. 5 is a flowchart illustrating reproduction processing in the display system.

As mentioned above, the display system 20 makes it possible for the UPnP Media Renderer Device processing unit 56 to use the UPnP Media Renderer Device.

The cellular phone 12 searches the UPnP Media Renderer Device (Block S201). When finding the UPnP Media Renderer Device (YES Block S202), the cellular phone 12 transmits an AVT (AVT:setAVtransportURI) action, and transmits a uniform resource locator (URL) for reproducing the content data stored in the cellular phone 12 through the HTTP (Block S203).

The processing unit 56 of the PC 11 receives the AVT action request, stores the URL which has been set as its argument in the HTTP request processing unit 57, and returns a response (Block S204). Then, a UPnP media renderer control point 60 calls out the AVT:Play action in order to reproduce the content data of the set URL (Block S205).

When receiving the AVT:Play action, the processing unit 56 of the PC 11 makes the CEC control unit 54 turn on the TV receiver 10 connected to the HDMI terminal 50 and perform processing so as to switch the input terminal of the TV receiver 10 to the HDMI terminal 32 (Block S206). For instance, the processing unit 56 executes ‘one touch play feature’ defined by the definition of the HDMI-CEC. More particularly, the processing unit 56 transmits ‘Image View On’ message via the CEC control unit 54, and turns on the TV receiver 10. The processing unit 56 switches the TV receiver 10 to a video reproducible state, transmits ‘Active Source’ message, and switches the input terminal of the TV receiver 10 to the HDMI terminal 32.

The processing unit 56 reports the URL stored in the HTTP request processing unit 57 of the computer 11 to the TV receiver 10 (Block S207), and issues an instruction to the TV receiver 10 so as to receive the reported RRL.

When receiving the ‘Image View On’ message, the TV receiver 10 switches the power source of the TV receiver 10 from a standby state to a power-on state, and switches the display unit 30 to a video reproduction mode. After receiving the ‘Active Source’ message, the TV receiver 10 switches an input path of the display unit 30 to an output path from the HDMI receiver processing unit 31 (Block S208).

The HTTP request processing unit 57 of the PC 11 makes an ‘HTTP Get’ request to an HTTP server 61 of the cellular phone 12 in accordance with the instruction from the processing unit 56 to acquire content, and transmits the acquired content to the decoding processing unit 52. The decoding processing unit 52 performs decoding processing on the basis of the data obtained from the HTTP request processing unit 57 (Block S209), and transmits the decoded content to the HDMI transmitter processing unit 51. The transmitter processing unit 51 transmits the content data to which the decoding processing is applied to the TV receiver 10 from the HDMI terminal 50. The HDMI receiver processing unit 31 of the TV receiver 10, which has received the decoded content data, converts the content data into a form capable of being displayed on the display device 30 to display the content data on the display unit 30 (Block S210).

While the foregoing embodiments have been described by using the wireless LAN as the wireless connection system, the invention is not limited to the embodiments; a wireless unit such as Bluetooth (registered trademark) and a cable connection such as Ethernet (registered trademark) may be accepted. While the decoding processing unit 52 of the PC 11 has decoded the content data received from the cellular phone 12, the decoding processing unit 52 may perform up-conversion processing of the content data if necessary so as to be convenient to be displayed on the TV receiver 10 with a large screen. Further, the aforementioned CEC control command is not limited to the ‘Active Source’ message, etc., as long as the control command in accordance with the specification of the HDMI-CEC, any CEC control command is usable.

According to the invention, when the apparatus connected through the HDMI to the TV receiver receives the content data from the external apparatus such as a cellular phone, the display system decodes the content data, automatically turns on the TV receiver, switches the connection to the HDMI, and may output the decoded content data. With disclosing the apparatus information onto the network, the cellular phone 12 may easily find the TV receiver 10 located on the network.

Further with performing the decoding processing by the PC 11, there is no need for the TV receiver 10 to include a decoder.

It is our intention that the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above. Further, the constituent elements over different embodiments may be appropriately

The present invention is made by taking such a circumstance given above into account; an object of the invention is to provide an information processor configured to display video obtained by reproducing content data which has been received from an external apparatus on a display device with a simple operation, and a control method and a display system of the information processor.

According to the invention, it is enabled to display video obtained by reproducing content data which has received from an external apparatus on a display device with a simple operation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a first connection module configured to output a video signal to a display device and to communicate a control signal to the display device;
a second connection module configured to receive a playback request signal of content data from an external terminal and to receive the content data, wherein the second connection module is different from the first connection module;
a start-up module configured to transmit, from the first connection module, the control signal to start up the display device upon receiving the playback request signal for the content data stored in the external terminal;
a decoding module configured to decode the content data to be received from the external terminal through the second connection module after the start-up module has started up the display device; and
an output module configured to output a video signal of the content data decoded by the decoding module from the first connection module.

2. The processor of claim 1, further comprising:
a playback function provision module configured to provide a function as a playback device to the external terminal, wherein
the playback function provision module is configured to switch whether or not the function as the playback device should be provided to the external terminal based on whether or not the first connection module is connected to the display device.

3. The processor of claim 1, wherein
the second connection module is configured to communicate by the universal plug and play (UPnP) standard, and
the playback function provision module is configured to provide a function as a Media Renderer Device.

4. The processor of claim 1, further comprising:
an acquisition module configured to acquire apparatus name information from the display device via the first connection module, wherein
the apparatus name information acquired by the acquisition module is enabled to be browsed by the external terminal via the second connection module.

5. A display system, comprising an external terminal, an information processor for receiving content from the external terminal, and a display device for displaying the content from the information processor, wherein the information processor comprises:
a first connection module configured to output a video signal to the display device and to communicate a control signal to the display device;
a second connection module configured to receive a playback request signal of content data from the external terminal and to receive the content data, wherein the second connection module is different from the first connection module;
a start-up module configured to transmit, from the first connection module, the control signal to start up the display device upon receiving the playback request signal of the content data stored in the external device;
a decoding module configured to decode the content data to be received from the external terminal through the second connection module after the start-up module has started up the display device; and
an output module configured to output a video signal of the content data decoded by the decoding module from the first connection module.

6. The system of claim 5, further comprising:
a playback function provision module configured to provide a function as a playback device to the external terminal, wherein
the playback function provision module is configured to switch whether or not the function as the playback device should be provided to the external terminal based on whether or not the first connection module is connected to the display device.

7. The system of claim 5, wherein
the second connection module is configured to communicate by an universal plug and play standard, and
the playback function provision module is configured to provide a function as a Media Renderer Device.

8. The system of claim 5, further comprising:
an acquisition module configured to acquire apparatus name information from the display device via the first connection module, wherein
the apparatus name information acquired by the acquisition module is enabled to be browsed by the external terminal via the second connection module.

9. A control method to be used in an information processor for receiving content from an external terminal and outputting the content to a display device, comprising:
outputting a video signal to the display device and communicating a control signal to the display device via first connection module;
receiving a playback request signal of content data from the external terminal and receiving the content data via a second connection module, wherein the second connection module is different from the first connection module;
transmitting the control signal to start up the display device from the first connection module when receiving the playback request signal for the content data stored in the external terminal;
decoding the content data to be received from the external terminal with the second connection module after starting up the display device; and
outputting a video signal of the decoded content data from the first connection module.

10. The method of claim 9, further comprising:
providing a reproduction device function to the external terminal; and
switching whether or not the reproduction device function should be provided to the external terminal based on whether or not the first connection module is connected to the display device.
